(19) United States
(12) Patent Application Publication
(10) Pub. No.: US 2013/0091978 A1
(43) Pub. Date: Apr. 18, 2013

(54) POSITIONING APPARATUS OF CAM PLATE FOR VEHICULAR AIR CONDITIONING SYSTEM

(71) Applicants: Yoon Hyung Lee, Gunpo-si (KR); Tae Yong Park, Daejeon (KR)

(72) Inventors: Yoon Hyung Lee, Gunpo-si (KR); Tae Yong Park, Daejeon (KR)

(73) Assignees: Hyundai Motor Company, Seoul (KR); HALLA CLIMATE CONTROL CORP., Daejeon (KR); Kia Motors Corp., Seoul (KR)

(21) Appl. No.: 13/480,071

(22) Filed: May 24, 2012

(30) Foreign Application Priority Data
Oct. 17, 2011 (KR) 10-2011-0105743

(51) Int. Cl. F16H 53/00

(52) U.S. Cl. 74/567

(57) ABSTRACT

A positioning apparatus of a cam plate for a vehicular air conditioning system may include the cam plate rotatably coupled to an air conditioning case by a cam shaft and including a guide slot, a plurality of positioning holes formed in the cam plate, a detent mechanism projecting from the air conditioning case toward the cam plate, and an arm rotatably coupled to the air conditioning case and including a connecting pin that may be slidably coupled to the guide slot of the cam plate, wherein, while the cam plate rotates about the cam shaft and the connecting pin included in the arm performs a camming action along the guide slot formed in the cam plate, a leading end of the detent mechanism may be selectively inserted into one of the positioning holes to detent the position of the cam plate when the connecting

### CROSS-REFERENCE TO RELATED APPLICATIONS

The present application claims priority to Korean Patent Application No. 10-2011-0105743 filed on Oct. 17, 2011, the entire contents of which is incorporated herein for purposes by this reference.

### BACKGROUND OF THE INVENTION

1. Field of the Invention

The present invention relates to a positioning apparatus of a cam plate for a vehicular air conditioning system, and more specifically, relates to a positioning apparatus of a cam plate for a vehicular air conditioning system capable of eliminating an idling section of the cam plate in each of the air conditioning modes.

2. Description of Related Art

Generally, as illustrated in FIG. 1, a control panel 1 for controlling an air conditioning system is provided in an instrument panel of a vehicle. The control panel 1 is provided with a regulating knob 2 for selecting an air conditioning mode.

The front surface of the regulating knob 2 has symbols formed on it that correspond to each of the air conditioning modes. For example, the symbols can include a Max A/C mode, a Vent mode, a Bi-level mode, a Floor mode, a Mix mode, a Defrost mode and a Mode off. A passenger can rotate the regulating knob 2 to select the desired air conditioning mode.

Meanwhile, as illustrated in FIGS. 1 and 2, when the structure in which the operation of selecting the air conditioning mode is performed mechanically, the regulating knob 2 and the cam plate 3 are connected to each other via a cable 4.

The cam plate 3 is rotatably coupled with an air conditioning case 6 via a cam shaft 5. The cam plate 3 is formed with a guide slot 7 into which a connecting pin 9 included in an arm 8 is inserted. The arm 8 is rotatably coupled with the air conditioning case 6 via a door shaft 11. The door shaft 11 is integrally formed with a door 13 which corresponds to each of the air conditioning modes and determines the extent to which a vent hole 12 included in the air conditioning case 6 opens.

Accordingly, the cam plate 3 rotates as the regulating knob 2 is operated to transmit an operating force via the cable 4. Owing to the rotation of the cam plate 3, the connecting pin 9 is rotates the arm 9 while performing a camming action along a curvature of the guide slot 7. Also, as the rotation of the arm 9 causes the door 13 to rotate, it is possible to regulate the extent to which the door 13 opens the vent hole 12.

Meanwhile, in the conventional air conditioning system that is operated by the cable as mentioned above, an idling section C1 having a constant angle is respectively assigned to each of the air conditioning modes A1 to A5 of the guide slot 7 as shown in FIG. 3 in order to absorb the operational variations of the cable 4.

Specifically, since the distances the cable 4 moves when being pulled and when being returned are different distances, the idling section C1 having the constant angle is respectively assigned to each of the air conditioning modes A1 to A5 of the guide slot 7 in order to absorb the operational variations of the cable due to the operation thereof. As a result, even if the cam plate 3 is made to rotate within the idling section C1, the arm 8 does not rotate and so the door 13 does not rotate either.

The idling section C1 is set within a range of approximately 3° in both clockwise and counterclockwise directions from the fixed position P1 of each of the air conditioning modes A1 to A5.

However, when the idling section C1 is assigned to each of the air conditioning modes A1 to A5 of the guide slot 7 in a state where the entire length of the guide slot 7 is fixed, an actual operational section C2 of the guide slot 7 other than the idling section C1 has a camming trace which does not follow a smooth curvature but forms an inflection section having a steep slope. As a result, since the feeling when being operated is degraded due to the presence of the inflection section, there are disadvantages such as requiring more effort and causing a quality problem due to the feeling when engaged.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a positioning apparatus of a cam plate capable of eliminating an idling section of the cam plate in each of the air conditioning modes. With this configuration, it is possible to eliminate an inflection section having a steep slope in a guide slot formed in the cam plate and thus to reduce an effort and eliminate a feeling of engagement. Furthermore, it is possible to improve a snapping feeling by imparting a secure operational feeling to each of the air conditioning modes.

In an aspect of the present invention, a positioning apparatus of a cam plate for a vehicular air conditioning system may include the cam plate rotatably coupled to an air conditioning case by a cam shaft and including a guide slot, a plurality of positioning holes formed in the cam plate, a detent mechanism projecting from the air conditioning case toward the cam plate, and an arm rotatably coupled to the air conditioning case and including a connecting pin that is slidably coupled to the guide slot of the cam plate, wherein, while the cam plate rotates about the cam shaft and the connecting pin may include d in the arm performs a camming action along the guide slot formed in the cam plate, a leading end of the detent mechanism is selectively inserted into one of the positioning holes to detent the position of the cam plate when the connecting pin is located in a position corresponding to each of air conditioning modes.

The detent mechanism may include a detent boss formed to project from an outer side of the air conditioning case toward the cam plate and provided therein with an operational groove being open toward the cam plate, a stopper engaged with the detent boss and movable along the operational groove, wherein a front side of the stopper is integrally provided with a projection to be inserted into one of the positioning holes, and an elastic member which may have one end supported on an inner end of the operational groove and the other end supported on a rear surface of the stopper and imparts an elastic force to the stopper to elastically bias the stopper toward the cam plate.

The positioning holes are formed in positions which are spaced apart from a center of the cam shaft by the same radius.

Diameters of the positioning holes are all the same diameter.

The guide slot formed in the cam plate is formed in an arc shape which may have a smooth curvature without an inflection section having a steep slope so as to reduce an effort and eliminate a feeling of engagement.

A leading end edge portion of the projection of the stopper and an edge portion of the positioning holes opposite to the projection are formed in an arc-shaped section which may have a constant curvature so as to absorb operational variations of the cable while the projection is smoothly inserted into the positioning holes.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a view illustrating an air conditioning system in which a regulating knob and a cam plate are connected to each other via a cable.

FIGS. 2 and 3 respectively illustrate a conventional air conditioning system.

FIG. 4 is a front view illustrating an air conditioning system including a positioning apparatus of the cam plate according to an exemplary embodiment of the present invention.

FIGS. 5 and 6 respectively illustrate a perspective view and a side view of FIG. 4.

FIG. 7 is a view illustrating a guide slot in the cam plate according to an exemplary embodiment of the present invention.

FIG. 8 is a cross-sectional view taken along the line I-I of FIG. 6.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Hereinafter, the positioning apparatus of the cam plate for the vehicular air conditioning system according to the exemplary embodiment of the present invention will be described in detail by referring to the accompanying drawings.

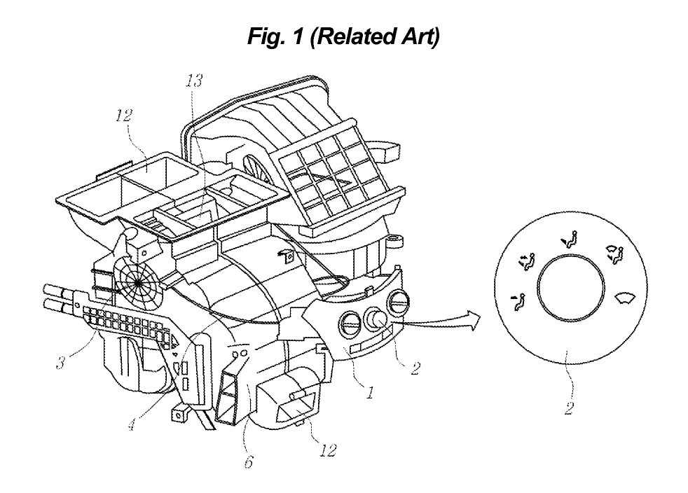

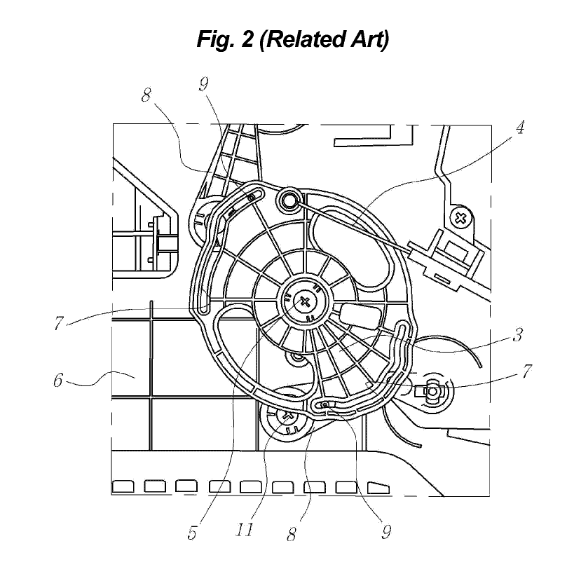

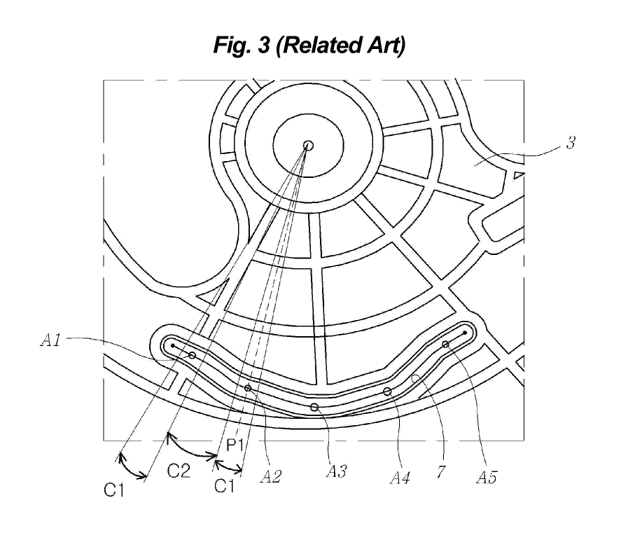

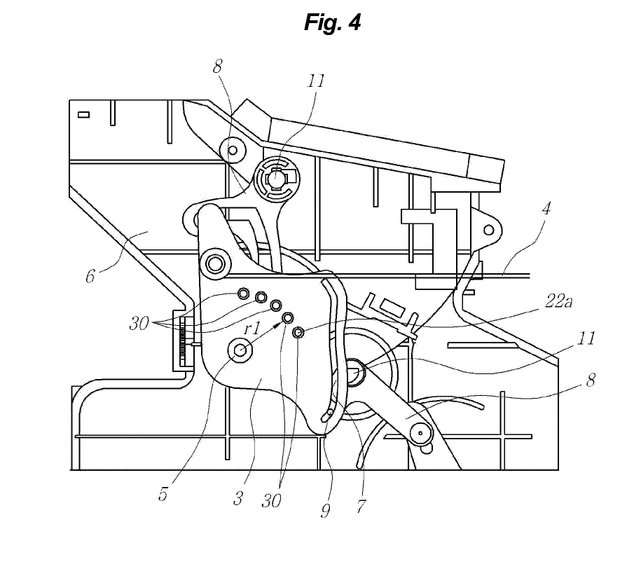

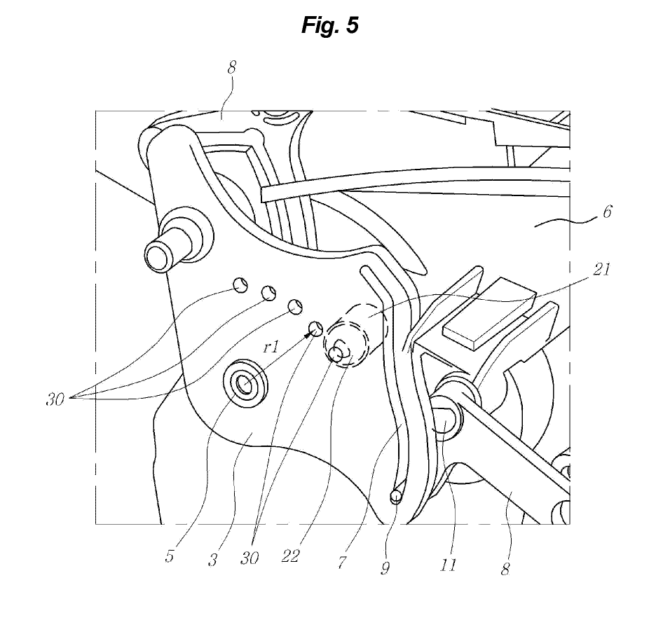

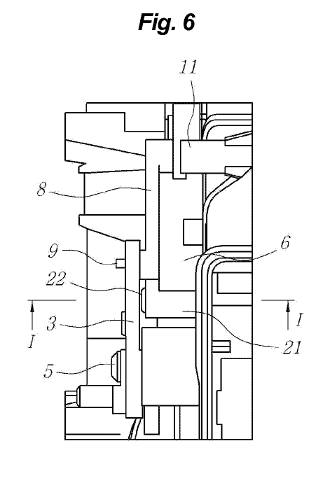

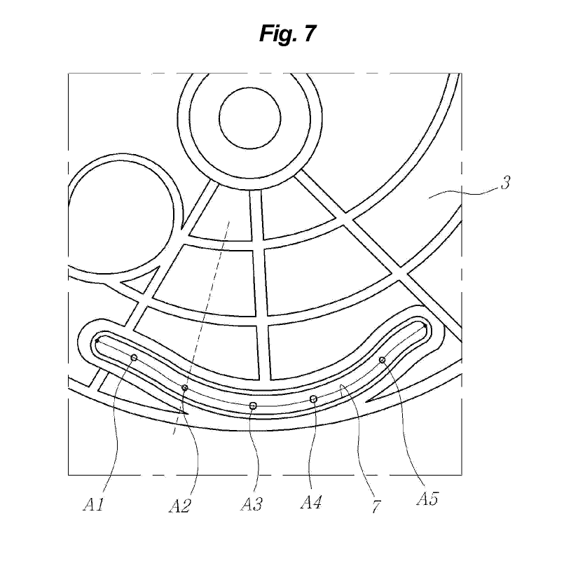

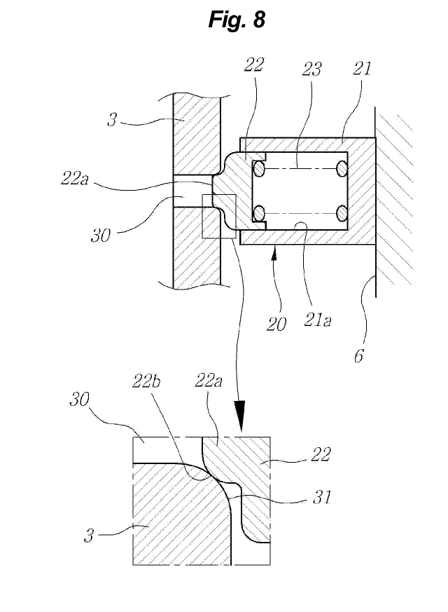

In an air conditioning system in which a regulating knob 2 (illustrated in FIG. 1) for selecting an air conditioning mode provided in an instrument panel and a cam plate 3 rotatably coupled with an air conditioning case 6 via a cam shaft 5 are connected to each other via a cable 4, as shown in FIGS. 4 and 8, the positioning apparatus of the cam plate according to an exemplary embodiment of the present invention includes a detent mechanism 20 configured to project from an air conditioning case 6 toward the cam plate 3, and a plurality of positioning holes 30 formed in the cam plate 3, and while the cam plate 3 rotates about a cam shaft 5 and a connecting pin 9 included in an arm 8 performs a camming action along a guide slot 7 formed in the cam plate 3a, a leading end of the detent mechanism 20 can be inserted into the plurality of positioning holes 30 to detent the position of the cam plate 3 when the connecting pin 9 is located in a position corresponding to each of the air conditioning modes A1 to A5.

As shown in FIG. 1, the front surface of the regulating knob 2 has symbols formed on it that each correspond to an air conditioning mode. For example, the symbols can include a Max A/C mode, a Vent mode, a Bi-level mode, a Floor mode, a Mix mode, a Defrost mode and a Mode off A passenger can rotate the regulating knob 2 to select a desired air conditioning mode.

The cam plate 3 is rotatably coupled with an air conditioning case 6 via a cam shaft 5. The cam plate 3 is formed with a guide slot 7 into which a connecting pin 9 included in an arm 8 is inserted. The arm 8 is rotatably coupled with the air conditioning case 6 via a door shaft 11.

A door 13 is provided which corresponds to each of the air conditioning modes and determines the degree to which a vent hole 12 included in the air conditioning case 6 opens. The door 13 is also integrally coupled to the door shaft 11.

Further, the detent mechanism 20 includes a detent boss 21 which is integrally formed to project from one side of the air conditioning case 6 toward the cam plate 3 and provided at its inside with an operational groove 21a that is open towards the cam plate 3, a stopper 22 which can be engaged with the detent boss 21 to move along the operational groove 21a and be integrally provided at its front side with a projection 22a that is inserted into the positioning holes 30, and an elastic member 23 which has one end supported on an inner end of the operational groove 21a and the other end supported on a rear surface of the stopper 22 and which imparts an elastic force to cause the stopper 22 to move toward the cam plate 3.

Although a compression coil spring can be used as the elastic member 23, the elastic member is not limited to this.

The positioning holes 30 are formed in positions which are spaced apart from a center of the cam shaft 5 by the same radius r1.

Specifically, since the detent mechanism 20 according to an exemplary embodiment of the present invention is fixedly provided in the air conditioning case 6, if the positioning holes 30 are formed in positions spaced away from a center of the cam shaft 5 by various radius, the projection 22a of the stopper 22 can be inserted into only one of the positioning holes 22 and the projection 22a cannot be inserted into the remaining positioning holes 22 when the cam plates 3 rotates. Accordingly, in order to achieve the object of the present invention, it is preferred that all of the positioning holes 30 be formed in positions spaced apart from a center of the cam shaft 5 by the same radius r1.

Further, it is preferred that the diameters of all of the positioning holes 30 be the same diameter so as to impart the same operational feeling and snapping feeling to a user in each of the air conditioning modes.

Also, a leading end edge portion 22b of the projection 22a of the stopper 22 and an edge portion 31 of the positioning holes 30 opposite to the projection 22a can be formed in an arc-shaped section which has a constant curvature so as to absorb operational variations of the cable 4 while the projection 22a is smoothly inserted into the positioning holes 30.

There is an operational variation in the air conditioning apparatus with the configuration described above due to inherent features of the cable 4. These operational variations in the cable 4 are the result of the different distances that the cable 4 moves when being pulled and when being returned.

Such operational variations of the cable 4 can be absorbed by the positioning apparatus according to an exemplary embodiment of the present invention.

That is, when the cam plate 3 is rotated about the cam shaft 5 in accordance with an operation of the regulating knob 2, the connecting pin 9 included in the arm 8 performs a camming action along a curvature of the guide slot 7.

At this time, when the connecting pin 9 reaches one position corresponding to one mode of the air conditioning modes A1 to A5, the projection 22a of the stopper 22 is inserted into the positioning holes 30 formed in the cam plate 3. And thus, the cam plate 3 is locked in a fixed position corresponding to any one mode selected by a user.

Accordingly, the operational variations of the cable 4 which occur upon selecting any one of the air conditioning modes A1 to A5 can be absorbed by inserting the projection 22a of the stopper 22 into the positioning holes 20 and thus correctly locating the position of the cam plate 3 in the air conditioning mode selected by a user.

Further, since the operational variations of the cable 4 can be absorbed by the detent mechanism 20 and the positioning holes according to an exemplary embodiment of the present invention, it is possible to form the guide slot 7 in an arc shape which has a smooth curvature over its entire length without the cam plate 3 having an inflection section with a steep slope. At the same time, it is also possible to eliminate the idling section of the guide slot 7 in each of the air conditioning modes A1 to A5.

In the prior art, since the guide slot 7 has an inflection section having a steep slope, the feeling when being operated is degraded, more effort is required and the feeling of engagement causes quality problems. On the contrary, in the exemplary embodiment of the present invention, since the guide slot 7 is formed in an arc shape which has a smooth curvature without the inflection section, it is possible to reduce the effort and eliminate the feeling of engagement. Furthermore, since a secure operational feeling can be imparted to each air conditioning mode, it is also possible to significantly improve the snapping feeling.

As is apparent from the above description, advantages of the positioning apparatus of the cam plate for the vehicular air conditioning system according to an exemplary embodiment of the present invention are that, since the operational variations of the cable can be absorbed and eliminated by the cam plate including the detent mechanism and the positioning holes when a user operates the regulating knob and selects an air conditioning mode, the idling section in each of the air conditioning modes can be eliminated in the guide slot, and the guide slot can be formed in an arc shape having a smooth curvature without an inflection section over the entire section thereof, it is possible to reduce the effort required and eliminate the feeling of engagement and also to impart a secure operational feeling to each of the air conditioning modes, thereby significantly improving a snapping feeling.

For convenience in explanation and accurate definition in the appended claims, the terms “upper”, “lower”, “inner” and “outer” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A positioning apparatus of a cam plate for a vehicular air conditioning system comprising:
the cam plate rotatably coupled to an air conditioning case by a cam shaft and including a guide slot;
a plurality of positioning holes formed in the cam plate;
a detent mechanism projecting from the air conditioning case toward the cam plate; and
an arm rotatably coupled to the air conditioning case and including a connecting pin that is slidably coupled to the guide slot of the cam plate;
wherein, while the cam plate rotates about the cam shaft and the connecting pin included in the arm performs a camming action along the guide slot formed in the cam plate, a leading end of the detent mechanism is selectively inserted into one of the positioning holes to detent the position of the cam plate when the connecting pin is located in a position corresponding to each of air conditioning modes.

2. The positioning apparatus of the cam plate for the vehicular air conditioning system according to claim 1, wherein the detent mechanism includes:
a detent boss formed to project from an outer side of the air conditioning case toward the cam plate and provided therein with an operational groove being open toward the cam plate;
a stopper engaged with the detent boss and movable along the operational groove, wherein a front side of the stopper is integrally provided with a projection to be inserted into one of the positioning holes; and
an elastic member which has one end supported on an inner end of the operational groove and the other end supported on a rear surface of the stopper and imparts an elastic force to the stopper to elastically bias the stopper toward the cam plate.

3. The positioning apparatus of the cam plate for the vehicular air conditioning system according to claim 1, wherein the positioning holes are formed in positions which are spaced apart from a center of the cam shaft by the same radius.

4. The positioning apparatus of the cam plate for the vehicular air conditioning system according to claim 1, wherein diameters of the positioning holes are all the same diameter.

5. The positioning apparatus of the cam plate for the vehicular air conditioning system according to claim 1, wherein the guide slot formed in the cam plate is formed in an arc shape which has a smooth curvature without an inflection section having a steep slope so as to reduce an effort and eliminate a feeling of engagement.

6. The positioning apparatus of the cam plate for the vehicular air conditioning system according to claim 2, wherein a leading end edge portion of the projection of the stopper and an edge portion of the positioning holes opposite to the projection are formed in an arc-shaped section which has a constant curvature so as to absorb operational variations of the cable while the projection is smoothly inserted into the positioning holes.
